(19) United States
(12) Patent Application Publication
(10) Pub. No.: US 2015/0204465 A1
(43) Pub. Date: Jul. 23, 2015

(54) COMPOSITE PIPE CONTAINING A THERMOSET MATRIX WITH CRACK ARRESTING ADDITIVES

(71) Applicant: Stephen EDMONDSON, Nobel, CA (US)

(72) Inventor: Stephen EDMONDSON, Nobel, CA (US)

(21) Appl. No.: 14/595,429

(22) Filed: Jan. 13, 2015

Related U.S. Application Data
(60) Provisional application No. 61/928,528, filed on Jan. 17, 2014.

(51) Int. Cl. F16L 9/12

(52) U.S. Cl. CPC F16L 9/12

(57) ABSTRACT

This relates to composite pipes containing unique thermoset matrix compositions, comprising crack arresting additive domains, including rubbers, which are distributed within the resin discontinuously prior to the resin curing so as to provide discontinuous distribution of the crack arresting additive domains within the final matrix composition.

### FIELD

This relates to composite pipes containing unique thermoset matrix compositions.

### BACKGROUND

Composite pipe designs are most commonly differentiated by the type of fiber used and the quantity and orientation of the fiber. The resin used to bind the fibers together to form a composite matrix is usually an un-modified polymer, which can be either thermoplastic or thermoset and the resin is usually not specifically formulated to give enhanced performance characteristics.

A typical failure mode of a composite pipe is thought to be associated with the fibre. For example when the pipe bursts (without the pipe being subject to any applied stress) or fails under cyclic loading, the failure is mainly considered dependent on the response of the fibre, since the modulus of the fibre is much higher than the modulus of the resin in the matrix.

Resin selection has not been thought to have a large bearing on the performance with respect to typical failure modes. Typical resin selection includes the use of un-modified resins (such as polyethylene, polypropylene or epoxy) to acts as binders between the fibres in the matrixes of most composite pipe designs.

The use of additives to improve the impact resistance of thermoplastic matrixes has also been previously described. For example additives that improve impact resistance are described in PCT/CA2012/050827), this approach, however, only applies to thermoplastic matrixes, the same approach would not work in a thermoset matrix.

The use of thermoset resins such as epoxies in composite pipe manufacture is well known. Companies such as FiberSpar™ (US 20120266996) use these resins to bind glass fibres together, to form a matrix that is a composite comprising epoxy resin and glass fibre, held in place between two polyethylene pipes. The standard epoxy resin is thought to have sufficient bond to the glass fibre and sufficient internal strength to resist the shear forces generated when the composite pipe is under pressure and can therefore be used to make a functional composite pipe.

However, the standard thermoset matrix, which contains such a standard epoxy resin, is rigid and therefore prone to cracking when the composite pipe is subject to impact such as from a falling object, since the impact force is not absorbed by the outer pipe. Such impact can cause micro-cracking of the epoxy resin within the matrix which causes the pipe to lose strength, and can subsequently lead the pipe to burst when the pipe is put under pressure and contains a fluid.

Another failure mode occurs when pressure cycles are applied to the pipe, micro-cracking of the epoxy can occur, again leading to a loss of strength and a subsequent burst when the pipe is under pressure and contains a fluid.

It is therefore desirable to provide modifications to the thermoset resin in an attempt to provide improved features to the composite pipe.

### SUMMARY

It is an object to obviate or mitigate at least one of the disadvantages of the prior art.

In a first aspect, is provided a composite pipe having an inner pipe held together to an outer pipe by a composite matrix, where the composite matrix is comprised of fibers and a thermoset resin and the thermoset resin contains a crack arresting additive which is discontinuously distributed within the thermoset resin, in domains.

In another embodiment, the crack arresting additive is a rubber. In yet other embodiments the rubber carboxylated butadiene-acrylonitrile, hydroxyl terminated polybutadiene (HTPB), liquid nitrile rubber (CTBN, ATBN) or acrylic acid modified rubber.

In yet other embodiments, the crack arresting additive is present in about 0.5 to about 10 percent by weight, about 0.5 to about 8 percent by weight, or about 0.5 to about 5 percent by weight of the composite matrix.

Other aspects and features will become apparent to those ordinarily skilled in the art, upon review of the following description of specific embodiments of the invention in conjunction with the accompanying figures.

### DETAILED DESCRIPTION

Modifications to thermoset resins, and methods of manufacturing composite pipes with such modified resins are suggested to provide improvements to prior art composite pipes.

Methods of manufacturing composite pipes are well known in the art. See for example U.S. Pat. No. 3,177,902, U.S. Pat. No. 3,489,626, and U.S. Pat. No. 6,306,320, all of which are incorporated herein by reference. In some instances, a, composite pipe can be manufactured by first producing an inner pipe by extruding a thermoplastic resin, through a die, then a layer of adhesive is applied to the inner pipe which is compatible with the thermoset matrix. Layers of reinforcing fiber are then wound around the inner pipe in a helical pattern, at an angle of 40-60° to the inner pipe, each subsequent layer at 90 o to the reinforcing layer beneath it. After each layer has been applied, a low viscosity epoxy resin is applied which is of sufficiently low viscosity to penetrate throughout the reinforcing fibers. The resin is then cured to form a thermoset composite matrix of cured resin and glass fiber, and an outer pipe is put in place to protect this matrix from moisture ingress.

In some embodiments, the inner pipe and outer pipe can both be made of high density polyethylene. In some embodiments, the inner and outer pipe are both made of thermoplastic material. In yet other embodiments, the inner and outer pipe may be made of different materials. In some embodiments, the inner pipe is about 5 to 12 mm in thickness, the outer pipe is about 5 to 12 mm in thickness, the adhesive layer is about 0.2 to 1mm in thickness, and the composite matrix is about 10 to 50 mm in thickness. In some embodiments the glass fiber is helically wound in layers at an angle of 40 to 50° to the inner pipe, and at 90 ° to the prior glass fiber layer. In some embodiments, the fibers are selected from the group consisting of glass fibers, carbon fibers and aramid fibers.

Thermoset resins used to form the composite matrix can include polyester, epoxy, phenolic, vinyl esters, polyurethanes, silicone, and polyamide and polamide-imide complexes.

Additives used to confer specific properties, such as flame retardancy, ultraviolet stability or electrical conductivity are well known in the art. These additives are normally dissolved into the bulk of the resin so as to provide even distribution of the additive throughout the resin. In contrast (and or in addition to these traditional additives), what is suggested is the introduction of an additive in such a manner as to form discontinuous distribution within the resin and create independent domains of additive within the composite matrix (“crack arresting additive domains”).

In some embodiments, the crack arresting additive can be rubber. A person skilled in the art would understand it is possible to produce a wide range in dispersion morphology paralleling a spectrum of the amount and degree of phase separated rubber through control of rubber-epoxy compatibility and cure conditions. It is proposed that these morphologies should result in different stress response mechanisms. Dissolved rubber is known to promote plastic deformation and necking at low strain rates that provide large increases in the elongation, and would not be considered to improve the composite pipes resistance to stress, for example, the impact of a falling object or pressure cycles. The introduction of phase separated rubber domains, however, are suggested to increase the elongation to break since cavitation is promoted at the interfacial boundary. The elongation is limited to the extent of cavitation and therefore large increases in the energy to break are not likely to be found. Thus the presence of rubber domains, which remain dispersed, but not dissolved in the resin is thought to be important to improve the composite pipes.

Epoxies with beneficial properties are produced by combining an epoxy resin which is adducted with a crack arresting additive, such as rubber. In some embodiments the rubber utilized is EPON Resin 58005 (a liquid epoxy adducted with 40% carboxylated butadiene-acrylonitrile rubber) which contains a high level (30-50%) of rubber. This epoxy adducted with rubber is mixed with a standard epoxy resin (with no rubber in) to give a resulting epoxy resin blend which has an appropriate amount of rubber (0.5 to 5% typically by weight), this is combined with sufficient curing agent to completely cure the epoxy groups present to form an epoxy resin blend that can be cured to form a thermoset epoxy resin.

The resultant cured epoxy resin will therefore have small domains of rubber contained within the epoxy resin that are proposed to give the resin/rubber mixture the ability to withstand micro-cracking on impact. These domains are not dissolved in the continuous phase, and comprise a minority of the resin by weight, therefore they do not have a significant effect on the modulus of the resin/rubber mixture, which is very dependent on the properties of the epoxy resin that forms the majority of the resin/rubber mixture. The resulting resin/rubber mixture has sufficient strength to withstand the shear forces that are exerted when the pipe is pressurized, and the compressive forces exerted when it is crimped, to form a connection to another pipe section.

### EXAMPLES

Formulations suitable for use as a matrix, which contains crack arresting additive domains can be made as follows:

| | | A | B | C | D | E | F |
|---|---|---|---|---|---|---|---|
| EPON Resin 826 | pbw | 100 | — | 90 | 95 | — | — |
| EPON Resin 862 | pbw | — | 100 | — | | 90 | 95 |
| EPON 58005 | pbw | | | 10 | 5 | 10 | 5 |
| LS-81K | pbw | 100 | 100 | 100 | 100 | 100 | 100 |
| Anhydride | | | | | | | |
| Curing Agent | | | | | | | |
| Viscosity @ 25° C.¹ | cP | 1200 | 900 | 1300 | 1300 | 1000 | 1000 |

In the above table, examples A and B describe known formulations suitable for use as reinforcement for composite structures. Examples C, D, E and F describe novel formulations that contain the crack arresting additive domains present in the EPON 58005 by way of example. All formulations are considered to have sufficiently low viscosity such that when applied to the reinforcing fiber that has been helically wound around the inner pipe, they will penetrate into the fiber. Each formulation has sufficient curing agent such that they can be cured by heating once applied.

Other resins which contain rubber containing adducts can also be used proving they have reactive groups that will react with either the epoxy resin or the curing agent.

What is claimed herein:

1. A composite pipe comprising an inner pipe held together with an outer pipe by a composite matrix, wherein the composite matrix is comprised of fibers and a thermoset resin, and wherein the thermoset resin contains a crack arresting additive which is discontinuously distributed within the thermoset resin.

2. The composite pipe of claim 1 wherein the crack arresting additive is a rubber.

3. The composite pipe of claim 1, wherein the rubber is carboxylated butadiene-acrylonitrile, hydroxyl terminated polybutadiene (HTPB), liquid nitrile rubber (CTBN, ATBN) or acrylic acid modified rubber.

4. The composite pipe of claim 1, wherein the crack arresting additive is about 0.5 to about 10 percent by weight of the composite matrix.

5. The composite pipe of claim 1, wherein the crack arresting additive is about 0.5 about 8 percent by weight of the composite matrix.
